(19) United States
(12) Patent Application Publication
(10) Pub. No.: US 2010/0103883 A1
(43) Pub. Date: Apr. 29, 2010

(54) DISTRIBUTED RESERVATION PROTOCOL ENHANCEMENT FOR BIDIRECTIONAL DATA TRANSFER

(75) Inventors: Soumya Das, San Diego, CA (US); Krishnan Rajamani, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/257,541

(22) Filed: Oct. 24, 2008

(51) Int. Cl. H04W 72/04

(52) U.S. Cl. 370/329

(57) ABSTRACT

A method for reserving bandwidth in a wireless system is provided. The method includes reserving one or more communications slots between two or more wireless devices communicating in a wireless network and providing preferential access to at least one wireless device across the network according to a first subset of the communications slots. The method also includes providing preferential access to at least one other device across the network during a second subset of the communications slots.

### BACKGROUND

I. Field

The following description relates generally to wireless communications systems, and more particularly to header compression systems and methods for wireless communication systems.

II. Background

Wireless communication systems are widely deployed to provide various types of communication content such as voice, data, and so forth. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems including E-UTRA, and orthogonal frequency division multiple access (OFDMA) systems.

An orthogonal frequency division multiplex (OFDM) communication system effectively partitions the overall system bandwidth into multiple (NF) subcarriers, which may also be referred to as frequency sub-channels, tones, or frequency bins. For an OFDM system, the data to be transmitted (i.e., the information bits) is first encoded with a particular coding scheme to generate coded bits, and the coded bits are further grouped into multi-bit symbols that are then mapped to modulation symbols. Each modulation symbol corresponds to a point in a signal constellation defined by a particular modulation scheme (e.g., M-PSK or M-QAM) used for data transmission. At each time interval that may be dependent on the bandwidth of each frequency subcarrier, a modulation symbol may be transmitted on each of the N_{F} frequency subcarrier. Thus, OFDM may be used to combat inter-symbol interference (ISI) caused by frequency selective fading, which is characterized by different amounts of attenuation across the system bandwidth.

Generally, a wireless multiple-access communication system can concurrently support communication for multiple wireless terminals that communicate with one or more base stations via transmissions on forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, where N_{S}≦min{N, N_{R}}. Generally, each of the NS independent channels corresponds to a dimension. The MIMO system can provide improved performance (e.g., higher throughput and/or greater reliability) if the additional dimensionalities created by the multiple transmit and receive antennas are utilized. A MIMO system also supports time division duplex (TDD) and frequency division duplex (FDD) systems. In a TDD system, the forward and reverse link transmissions are on the same frequency region so that the reciprocity principle allows estimation of the forward link channel from the reverse link channel. This enables an access point to extract transmit beam-forming gain on the forward link when multiple antennas are available at the access point.

One common application for data transfer in wireless systems is in line-of-sight ultra wide band systems. For example, two devices that are both downloading and uploading data to each other in a concurrent manner. If left unchecked, it is possible for one of the devices to unfairly utilize more available bandwidth than the other device. Also, it is possible, that bandwidth can be wasted if protocol is not administered properly. One standard that considers these issues is ECMA-368 MAC. However, this standard does not specify a technique for a pair of devices (A & B) to have distributed reservation protocol (DRP) reservations so as to maximize the respective combined throughput when the traffic pattern varies dynamically in both directions.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its sole purpose is to present some concepts in a simplified form as a prelude to the more detailed description that is presented later.

Systems and methods utilize protocol enhancements for optimal use of private distributed reservation protocol (DRP) reservations for bidirectional traffic, where various protocol options facilitate shared medium access by two or more devices. Various protocols are directed at utilizing DRP reservations along with prioritized contention access (PCA) to maximize overall system throughput while maintaining fairness for bidirectional transfer of data between devices. For example, A and B are devices and there is bidirectional data transfer between the devices. There can be an ultra wideband (UWB) link between A and B. Thus, the ratio of traffic between A->B to B->A can be considered as (downlink:uplink) with knowledge of a priori information. If a priori information regarding the traffic ratio is not available it can be considered equal. The enhanced protocols can be provided as extensions to previous wireless protocols and can enhance bidirectional applications running on top of ECMA-368 MAC for example. This promotes efficient use of bandwidth and yet maintains fairness amongst devices involved with bi-directional transfer and while maximizing overall system throughout.

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features may become apparent from the following detailed description when considered in conjunction with the drawings.

### BRIEF DESCRIPTION OF THE DRAWINGS

FIG. 1 is a high level block diagram of a system that employs an enhanced reservation protocol to increase efficiencies in a wireless network.

FIG. 2 illustrates alternative protocols that can be employed in conjunction with a base reservation protocol.

FIG. 3 illustrates an alternative reservation protocol that can be employed in conjunction with a base reservation protocol.

FIG. 4 illustrates reservation protocol combinations.

FIG. 5 illustrates a wireless communications method that utilizes a reservation protocol.

FIG. 6 illustrates an example logical module for a reservation protocol.

FIG. 7 illustrates an example logical module for an alternative reservation protocol.

FIG. 8 illustrates an example communications apparatus that employs adjustable compression and decompression protocols.

FIG. 9 illustrates a multiple access wireless communication system.

FIGS. 10 and 11 illustrate example communications systems that can be employed with dynamically adjustable network parameters.

### DETAILED DESCRIPTION

Systems and methods are provided to dynamically adjust network protocols to increase efficiencies in the network and maintain fairness between devices. Fairness relates to the concept where each device in the network is given substantially equal access (or according to need) to broadcast or receive data on the network. In one aspect, a method for reserving bandwidth in a wireless system is provided. The method includes reserving one or more communications slots between two or more wireless devices communicating in a wireless network and providing preferential access to at least one wireless device across the network according to a first subset of the communications slots. The method also includes providing preferential access to at least one other device across the network during a second subset of the communications slots.

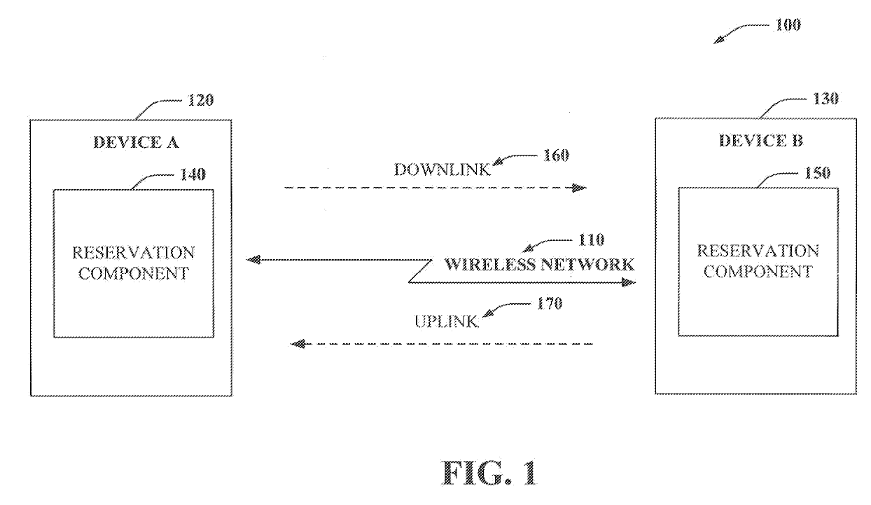

Referring now to FIG. 1, a system 100 employs an enhanced reservation protocol to increase efficiencies in a wireless network 110. The system 100 includes a first device 120 (also referred to as device A) which can be an entity capable of communication over the wireless network 110 to a second device 130. For instance, each device 110 and 120 can be an access terminal (also referred to as terminal, user equipment, or mobile device). Each of the devices 120 and 130 include a reservation component 140 and 150 respectively, where the reservation component is provided to maintain network access fairness between the devices and to improve efficiencies of the devices across the network 110. As shown, device A 120 communicates to device B130 via downlink 160 and receives data via uplink 170. Such designation as uplink and downlink is arbitrary as device B 130 can also transmit data via downlink and receive data via uplink channels. It is noted that although two devices are shown, that more than two devices can be employed on the network 110, where such additional devices can also be adapted for the reservation protocols described herein.

The reservation components 140, 150 provide protocol enhancements for optimal use of private distributed reservation protocol (DRP) reservations for bidirectional traffic (or omni-directional), where various protocol options facilitate shared medium access by two or more devices. Various protocols are directed at utilizing DRP reservations along with prioritized contention access (PCA) to maximize overall system throughput while maintaining fairness for bidirectional transfer of data between devices. For example, device A 120 and device B 130 have bidirectional data transfer between the devices via downlink 160 and uplink 170. There can be an ultra wideband (UWB) link between A and B. Thus, the ratio of traffic between A->B to B->A can be considered as (downlink:uplink, d:u) with knowledge of a priori information. If a priori information regarding the traffic ratio is not available it can be considered equal. The enhanced protocols can be provided as extensions to previous wireless protocols and can enhance bidirectional applications running on top of ECMA-368 MAC for example. This promotes efficient use of bandwidth and yet maintains fairness amongst devices involved with bidirectional transfer and while maximizing overall system throughout.

In one aspect, assume that device A 120 is a DRP reservation owner and device B 130 is a reservation target for the DRP reservation. However, there is no distinction with respect to channel access between the owner and target. Also, assume that there are a total of N medium access slots (MAS) slots in an observation window over which one would base the following analysis. In one aspect, it is desirable to have certain minimum number of MAS slots for reservation per time interval T where T is governed by a latency requirement. For file delivery, the latency requirement is somewhat relaxed. Also the N slots should not be confined to 1 super frame and can span across multiple super frames.

To satisfy the above constraints, divide the first αN (where 0<α<1) MAS slots between A and B in the ratio of their respective traffic proportions. Thus, out of α/N slots, A will have preferential access in

$$α N \frac{d}{d + u}$$

slots while B will have preferential access in

$$α N \frac{u}{d + u}$$

slots.

By preferential access for a device, this implies that the device will not need to contend for access whereas the other device has to contend for access during that period and will gain access if the first device does not have data in its buffer to transmit. Thus, this is a type of soft DRP between the reservation owner and target for the context of bidirectional transfer and is a private DRP reservation to the external world. Assigning devices preferential access according to private DRP reservations is referred to below as the base protocol or solution. The base protocol will be employed with all the other protocol embodiments described herein.

It is noted that the system 100 can be employed with an access terminal or mobile device, and can be, for instance, a module such as an SD card, a network card, a wireless network card, a computer (including laptops, desktops, personal digital assistants PDAs), mobile phones, smart phones, or any other suitable terminal that can be utilized to access a network. The terminal accesses the network by way of an access component (not shown). In one example, a connection between the terminal and the access components may be wireless in nature, in which access components may be the base station and the mobile device is a wireless terminal. For instance, the terminal and base stations may communicate by way of any suitable wireless protocol, including but not limited to Time Divisional Multiple Access (TDMA), Code Division Multiple Access (CDMA), Frequency Division Multiple Access (FDMA), Orthogonal Frequency Division Multiplexing (OFDM), FLASH OFDM, Orthogonal Frequency Division Multiple Access (OFDMA), or any other suitable protocol.

Access components can be an access node associated with a wired network or a wireless network. To that end, access components can be, for instance, a router, a switch, or the like. The access component can include one or more interfaces, e.g., communication modules, for communicating with other network nodes. Additionally, the access component can be a base station (or wireless access point) in a cellular type network, wherein base stations (or wireless access points) are utilized to provide wireless coverage areas to a plurality of subscribers. Such base stations (or wireless access points) can be arranged to provide contiguous areas of coverage to one or more cellular phones and/or other wireless terminals.

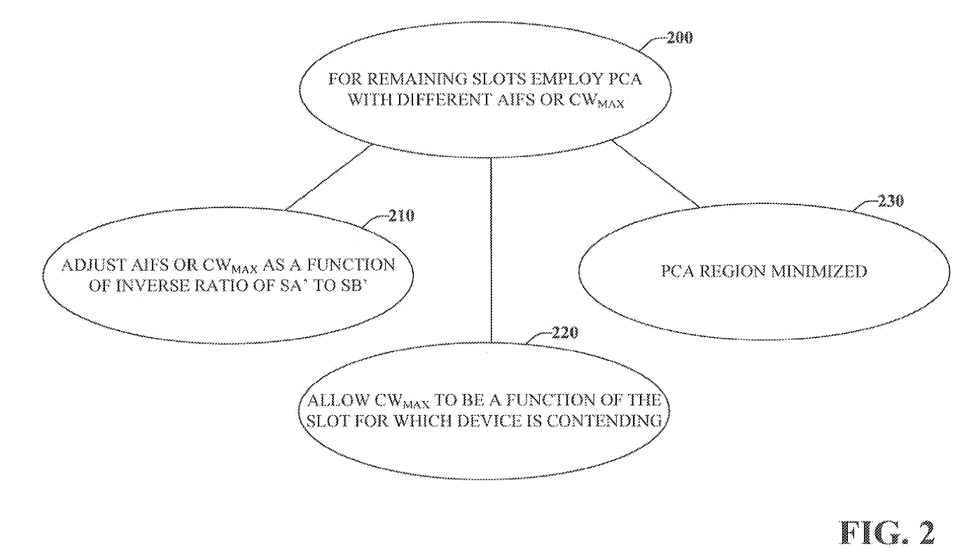

Turning to FIG. 2, alternative protocols 200 are provided that can be employed in conjunction with the base protocol described in FIG. 1. In the remaining (1−α)N MAS slots described above with respect to the base protocol, at 200 the remaining slots can employ prioritized contention access (PCA) with arbitrary inter-frame spacing (AIFS) and/or contention window maximum (CWₘₐₓ) for the devices A and B being scaled so as to ensure fairness over the DRP reservation. For example, let S_{A} and S_{B} be the number of MAS slots in which A and B had transmitted data during the first αN MAS slots. It can be assumed that even if any MAS slot is not fully utilized, consider it as 1 MAS slot for the device which transmitted during that MAS slot. Also let S_{A}′ and S_{B}′ be the number of MAS slots during the PCA period over which A and B are assigned access to the medium so as to share the entire reservation in a fair manner. Thus, the total number of MAS slots during which A transmits=N_{A}=S_{A}+S_{A}′ Equation (1).

Similarly, the total number of MAS slots during which B transmits=N_{B}=S_{B}+S_{B}′ Equation (2). The ratio of slots during which

$$A and B transmitted = \frac{{N}_{A}}{{N}_{B}} = \frac{{S}_{A} + {S}_{A}^{′}}{{S}_{B} + {S}_{B}^{′}} . \qquad Equation ( 3 )$$

This ratio should be as close to

$$\frac{d}{u}$$

(download/upload) to ensure fairness when either A or B or both did not have data to transmit during some MAS slots of the first αN MAS slots and later have data to transmit during the PCA period. If both A and B had buffer under-runs in the soft DRP reservation period, then this will ensure that the ratio of S_{A}′ to S_{B}′ is close to

$$\frac{d}{u} .$$

However, if one of these (e.g., A) had buffer under-run and the other (e.g., B) did not, then this should try to assign more MAS slots to the former device (A) so that it is not penalized for the late data arrival in its buffer. Thus, this protocol 200 performs a trade-off between reduction in utilization efficiency with PCA overhead and increasing fairness for the former device (A) that did not have data to transmit during its contention free access. This protocol may penalize the latter device (B) to some extent in maintaining fairness for the former device (A) by distributing the load for unutilized MAS slots when the former device (A) did not have data to transmit. However, if the other device (B) had data to transmit during those MAS slots, it would decrease its share of penalty. Thus,

$$\frac{{S}_{A} + {S}_{A}^{′}}{{S}_{B} + {S}_{B}^{′}} = \frac{d}{u} . \qquad Equation ( 4 )$$

Proceeding to 210, another variant of the protocols previously described is provided. In this aspect, the AIFS and/or CWₘₐₓ for devices A and B can be adjusted as a function of the inverse ratio of S_{A}′ to S_{B}′ at 210. Therefore, for the PCA period,

$$\frac{{CW}_{max , A}}{{CW}_{max , B}} = f ( \frac{{S}_{B}^{′}}{{S}_{A}^{′}} ) . \qquad Equation ( 5 )$$

The following examples illustrate how the ratio of S_{A}′ to S_{B}′ is determined at the beginning of the PCA period.

### EXAMPLE 1

| | Slots won during | |
|---|---|---|
| Node | contention free access | Slots to be won during PCA |
| A | S_{A} = 10 | S_{A}′ = x |
| B | S_{B} = 30 | S_{B}′ = y |

### Let,

$$α = 0.5 ; \frac{d}{u} = \frac{1}{2} ; N = 100 and R = \frac{x}{x + y}$$

Thus, assume 10 MAS slots were idle during the contention free access duration. To have the ratio of MAS slots of A and B over the entire reservation

$$\frac{R ( 1 - α ) N + {S}_{A}}{( 1 - R ) ( 1 - α ) N + {S}_{B}} = \frac{d}{u}$$

$$\text{=} \text{>} \frac{R ( 1 - α ) 100 + 10}{( 1 - R ) ( 1 - α ) 100 + 30} = \frac{d}{u}$$

$$\text{=} \text{>} \frac{50 R + 10}{( 1 - R ) 50 + 30} = \frac{1}{2}$$

$$\text{=} \text{>} 100 R + 20 = 80 - 50 R$$

$$\text{=} \text{>} 150 R = 60$$

$$\text{=} \text{>} R = 2 / 5$$

$$\text{=} \text{>} \frac{{S}_{A}^{′}}{{S}_{B}^{′}} = \frac{x}{y} = \frac{2}{3}$$

### EXAMPLE 2

| | Slots won during | |
|---|---|---|
| Node | contention free access | Slots to be won during PCA |
| A | S_{A} = 10 | S_{A}′ = x |
| B | S_{B} = 30 | S_{B}′ = y |

### Let,

$$α = 0.4 ; \frac{d}{u} = \frac{1}{3} ; N = 100$$

In this example, there are no MAS slots idle during the contention free access duration.
Here, we have

$$\frac{R ( 1 - α ) N + {S}_{A}}{( 1 - R ) ( 1 - α ) N + {S}_{B}} = \frac{d}{u}$$

$$\text{=} \text{>} \frac{R ( 1 - α ) 100 + 10}{( 1 - R ) ( 1 - α ) 100 + 30} = \frac{d}{u} = \frac{1}{3}$$

$$\text{=} \text{>} \frac{60 R + 10}{60 - 60 R + 30} = \frac{1}{3}$$

$$\text{=} \text{>} 180 R + 30 = 90 - 60 R$$

$$\text{=} \text{>} R = 1 / 4$$

$$\text{=} \text{>} \frac{{S}_{A}^{′}}{{S}_{B}^{′}} = \frac{x}{y} = \frac{1}{3}$$

Now, R being a ratio must satisfy the constraint 0≦R≦1. Also R(A)+R(B)=1 i.e., the ratios for A and B's share of MAS slots should add up to 1. If for a given scenario, a value of R<0 is determined, then clip the value of R to 0. Similarly, if for a given scenario, a value of R>1 is determined, then clip the value of R to 1. These two are generally equivalent as R(A)<0 [symbol] R(B)>1 and vice versa. This implies that for the given scenario, even if given all the remaining MAS slots to one of the devices, the system cannot maintain the ratio of MAS slots over the entire DRP reservation as

$$\frac{d}{u} .$$

Thus, perform the best possible e.g., allocate all the MAS slots to one device and make it the reservation owner (PCA not needed then).

The following are some example assumptions that were employed to derive the above equations. It is to be appreciated that the assumptions provide general guidelines and are not controlling in all instances. For instance, assume that the PCA region is placed after the soft DRP region thereby making maximum use of it. Previous methods were aimed to utilize DRP reservation to maximize the combined throughput of the devices, when the demand varies dynamically in the two directions. It is apparent that α=1 ensures better utilization efficiency, as with α<1 there is contention overhead for PCA in the (1−α)×N slots. However, the reduced utilization efficiency is compensated by ensuring fairness when the traffic for any of the devices A or B is bursting leading to buffer under-runs during contention free access and data come later during the PCA period.

The value of a thus offers a trade-off between utilization and fairness. Higher a leads to higher utilization while lower value of α increases fairness under the situation described above. The PCA region should be more than a certain minimum number of MAS slots for meaningful use. The value of α need not be maintained constant and can be adjusted in subsequent DRP reservations after monitoring the traffic pattern of both devices for a few superframes.

If no a priori knowledge about traffic patterns of the devices exist, the initial value of d:u can be considered as 1:1 and the ratio can be adjusted according to the observed traffic pattern of both devices for a few superframes. When a device wins contention for the medium, it continues to transmit data until its buffer is empty or TXOP (transmit opportunity) expires. The TXOP can be more than 1 MAS slot. There is an increased probability of collisions when ratio of CWₘₐₓ values for both devices is close to 1.

Proceeding to 220 of FIG. 2, an alternative reservation protocol is provided. In protocol 210 described above, a scaled CWₘₐₓ was proposed for devices A and B based on the MAS slot usage during the contention free access period and CWₘₐₓ for both the devices are kept substantially constant for the PCA period.

In this aspect at 220, the initial ratio of CWₘₐₓ of two devices is kept the same as that in protocol 210. When a device wins contention for the medium, it continues to transmit data till its buffer is empty or TXOP expires. The devices again contend for access the next time it has data to transmit.

If any device completes transmission before the end of the MAS slot, the other device does not need to wait for the next MAS slot to begin and can start contending for the medium when it senses the medium idle, however, any partial MAS slot usage is counted as 1 MAS slot usage. Depending on the MAS slots won by each device during the PCA period, the CWₘₐₓ for each device for the next MAS slot is adjusted. Thus, CWₘₐₓ for each device is a function of the MAS slot for which device is contending.

At the beginning of slot 1,

$$\frac{{CW}_{max , A} ( 1 )}{{CW}_{max , B} ( 1 )} = f ( \frac{{S}_{B}^{′}}{{S}_{A}^{′}} ) . \qquad Equation ( 6 )$$

If A wins slot s, then at the beginning of slot (s+1), CW_{max,A} remains unchanged, while CW_{max,B} is reduced. On the other hand, if B wins slot s, then at the beginning of slot (s+1), CW_{max,A} is reduced while CW_{max,B} remains unchanged. Therefore, if A wins slot s:

CW_{max,A}(s+1)=CW_{max,A}(s) Equation (7).

$${CW}_{max , B} ( s + 1 ) = {CW}_{max , B} ( s ) \frac{{CW}_{max , B} ( s ) - 1}{{CW}_{max , B} ( s )} = {CW}_{max , B} ( s ) - 1. \qquad Equation ( 8 )$$

On the other hand, if B wins slot s:

$$\begin{matrix}{CW}_{max , A} ( s + 1 ) = {CW}_{max , A} ( s ) \frac{{CW}_{max , A} ( s ) - 1}{{CW}_{max , A} ( s )} = {CW}_{max , A} ( s ) - 1. & Equation ( 9 ) \\ {CW}_{max , B} ( s + 1 ) = {CW}_{max , B} ( s ) . & Equation ( 10 )\end{matrix}$$

One justification of this protocol is as follows. The ratio of CWₘₐₓ between devices ensures that amongst a large number of channel access contentions, the number of times each device wins will similar as the ratio of CWₘₐₓ probabilistically speaking. However, there might not be that many MAS slots in the PCA period for this to occur. This method provides a manner of forcing the ratio to be as close as its desired value to ensure fairness. The benefit of this protocol may be incremental with large α and it incurs additional cost of computation. Also, there is an increased probability of collisions when ratio of CWₘₐₓ values for both devices is close to 1 at the beginning of any given slot. The table below gives an illustration.

Assume at the beginning of the PCA period,

$$\frac{{CW}_{max , A}}{{CW}_{max , B}} = \frac{4}{6} . \qquad Equation ( 11 )$$

| | | | | | |
|---|---|---|---|---|---|
| MAS Slot | 1 | 2 | 3 | 4 | 5 |
| Device winning MAS slot | A | A | B | A | . . . |
| $\frac{C {W}_{max , A}}{C {W}_{max , B}}$ | $\frac{4}{6}$ | $\frac{4}{5}$ | $\frac{4}{4}$ | $\frac{3}{4}$ | . . . |

Another alternative protocol is provided at 230. If over time, it is observed that the ratio of CWₘₐₓ for A and B is close to the values needed for the d:u share of MAS slots during PCA period, then the duration of contention free access can be increased e.g., a can be increased and can be stretched to 1 eliminating the PCA region as fairness is not an issue. If the ratio of CWₘₐₓ for A and B is different from the values needed for the d:u share of MAS slots during PCA period, then a second contention free access period can be provided instead of the PCA period. In the second contention free access period, the ratio of MAS slots for which A and B have preferential access will not be

$$\frac{d}{u}$$

but

$$\frac{{S}_{A}^{′}}{{S}_{B}^{′}}$$

i.e.

$$\frac{{CW}_{max , A}}{{CW}_{max , B}}$$

computed from the base solution in FIG. 1. This implies that DRP reservation period is repartitioned adjusting the MAS slots for preferential access for the two devises. The number of partitions can be more than 2. In the case, where N is distributed among a number of superframes, the system can decide to have partitions for each superframe and adjust the ratio of MAS slots for preferential access for A and B.

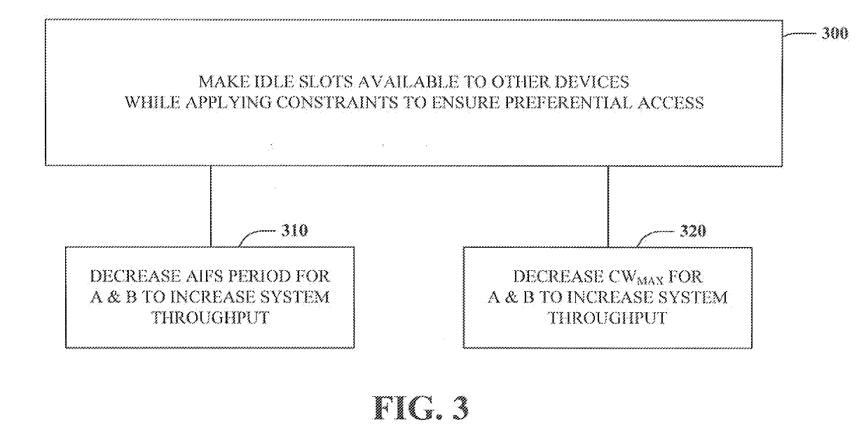

Referring to FIG. 3, an alternative reservation protocol 300 is provided. During the PCA period, the idle MAS slots (not utilized by A and B) can be made available to other devices at 300. One method of providing preferential access to A and B during the PCA period is to have a smaller AIFS period at 310 and/or a smaller CWₘₐₓ at 320 for A and B compared to other devices. This will increase the system throughput and compensate the decrease in utilization introduced by PCA region as discussed previously. Thus, CW_{max,N}N>max(CW_{max,A},CW_{max,B}) where N ∈ {A,B} Equation (12). The above constraint ensures that A and B have a preferential access to the medium (in a probabilistic sense) compared to other devices. This can also be extended to the contention free access period when MAS slots are idle e.g., neither A nor B has data to transmit.

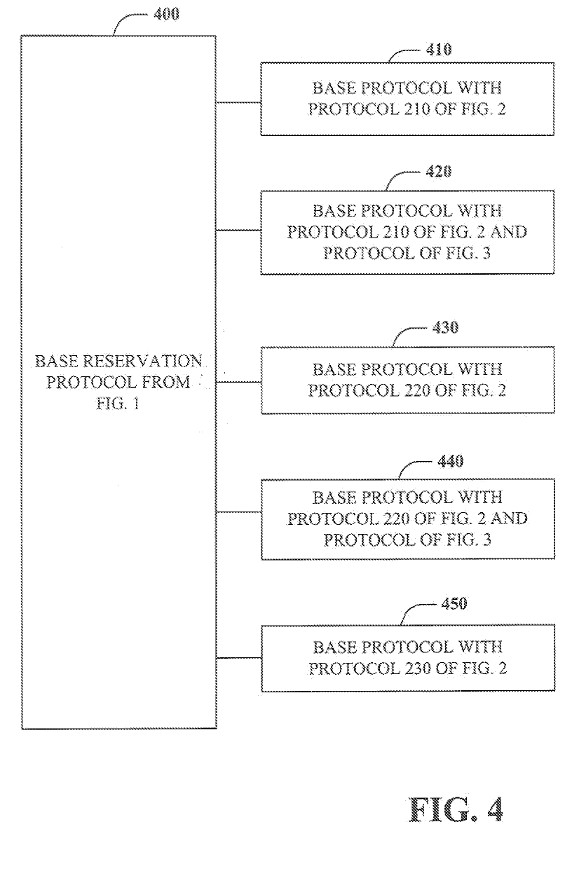

Referring to FIG. 4, reservation protocol combinations are provided. At 400, the base reservation protocol described above with respect to FIG. 1 is illustrated. In addition to the base protocol 400, additional protocols can be employed in conjunction with the base protocol. For example, at 410, the base protocol of FIG. 1 can be utilized in conjunction with the protocol described at 210 of FIG. 2. At 420, the base protocol 400 can be employed with the protocol 210 of FIG. 2 and the protocols 300 of FIG. 3. At 430, the base protocol 400 can be employed with the protocol 220 of FIG. 2. At 440, the base protocol 400 can be employed with protocol 220 of FIG. 2 and the protocols 300 of FIG. 3. At 450, the base protocol of 400 can be utilized in conjunction with the protocol 230 of FIG. 2. As can be appreciated, other protocol combinations than described here can also be employed.

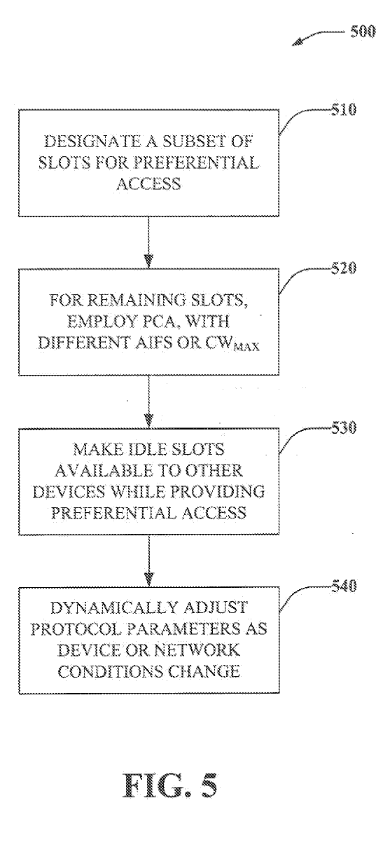

Referring now to FIG. 5, a wireless communications methodology 500 is illustrated. While, for purposes of simplicity of explanation, the methodology (and other methodologies described herein) are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be utilized to implement a methodology in accordance with the claimed subject matter.

Proceeding to 510, a subset of communications slots are designated for preferential access. As noted previously, divide the first αN (where 0<α<1) MAS slots between A and B in the ratio of their respective traffic proportions. Thus, out of αN slots, A will have preferential access in

$$α N \frac{d}{d + u}$$

slots while B will have preferential access in

$$α N \frac{u}{d + u}$$

slots. By preferential access for a device, this implies that the device will not need to contend for access whereas the other device has to contend for access during that period and will gain access if the first device does not have data in its buffer to transmit. At 520, for remaining slots, employ parameters PCA, AIFS, or CWₘₐₓ to dynamically adjust device access. As noted previously, these methods include protocol adjustments described above with respect to protocols 200-230 of FIG. 2. At 530, idle slots can be made available to other devices while providing preferential access between devices. These methods can include the protocols described above with respect to FIG. 3. At 540, as conditions change over time, parameters such as a, PCA, AIFS, CWmax, and others can be dynamically adjusted to facilitate the most efficient usage of network resources and to facilitate that each device is given a substantially equal or fair chance to communicate data over the network.

The techniques described herein may be implemented by various means. For example, these techniques may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. With software, implementation can be through modules (e.g., procedures, functions, and so on) that perform the functions described herein. The software codes may be stored in memory unit and executed by the processors.

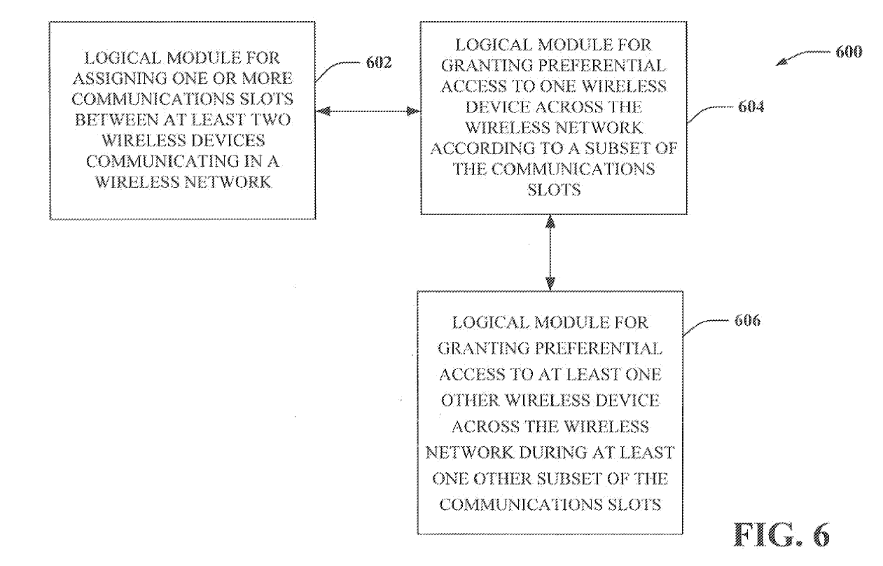

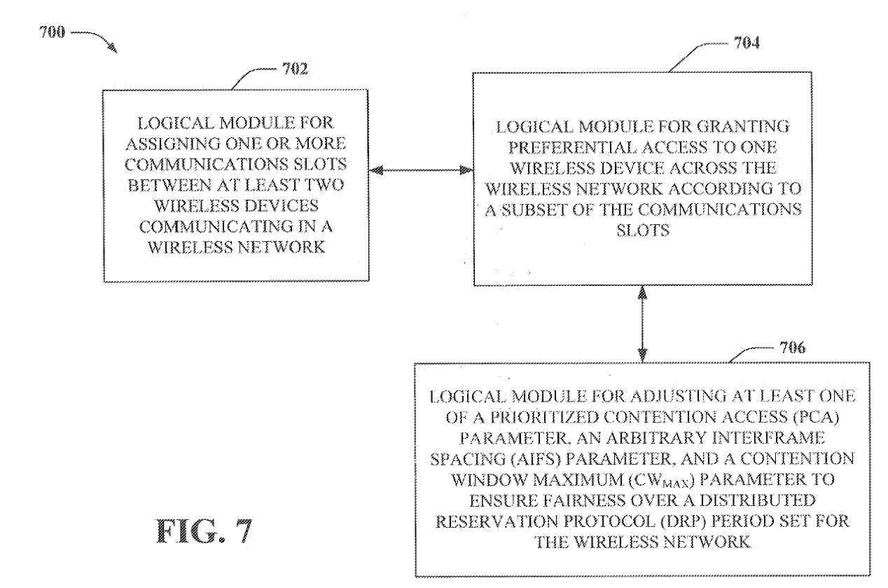

Turning now to FIGS. 6 and 7, a system is provided that relates to wireless signal processing. The systems are represented as a series of interrelated functional blocks, which can represent functions implemented by a processor, software, hardware, firmware, or any suitable combination thereof.

Referring to FIG. 6, a wireless communication device 600 is provided. The device 600 includes a logical module 602 for assigning one or more communications slots between at least two wireless devices communicating in a wireless network. This includes a logical module 604 for granting preferential access to one wireless device across the wireless network according to a subset of the communications slots. The device 600 also includes a logical module 606 for granting preferential access to at least one other wireless device across the wireless network during at least one other subset of the communications slots.

Referring to FIG. 7, a wireless communication system 700 is provided. The system includes a logical module 702 for assigning one or more communications slots between at least two wireless devices communicating in a wireless network. The system 700 also includes a logical module 704 for granting preferential access to one wireless device across the wireless network according to a subset of the communications slots. The system also includes a logical module 706 for adjusting at least one of a prioritized contention access (PCA) parameter, an arbitrary interframe spacing (AIFS) parameter, and a contention window maximum (CWmax) parameter to ensure fairness over a distributed reservation protocol (DRP) period set for the wireless network.

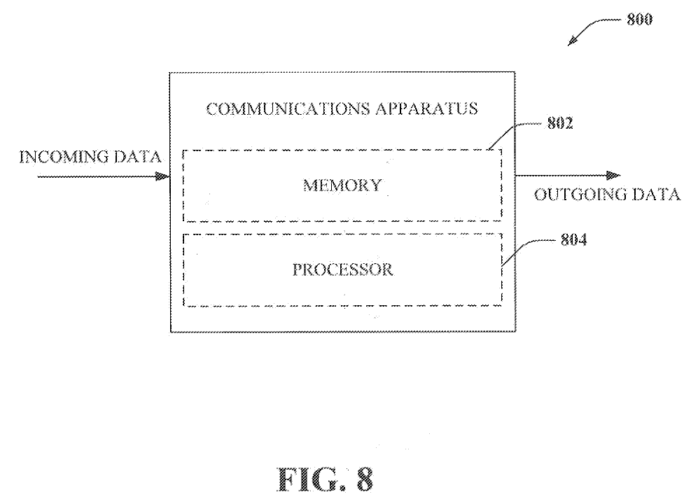

FIG. 8 illustrates a communications apparatus 800 that can be a wireless communications apparatus, for instance, such as a wireless terminal. Additionally or alternatively, communications apparatus 800 can be resident within a wired network. Communications apparatus 800 can include memory 802 that can retain instructions for performing a signal analysis in a wireless communications terminal. Additionally, communications apparatus 800 may include a processor 804 that can execute instructions within memory 802 and/or instructions received from another network device, wherein the instructions can relate to configuring or operating the communications apparatus 800 or a related communications apparatus.

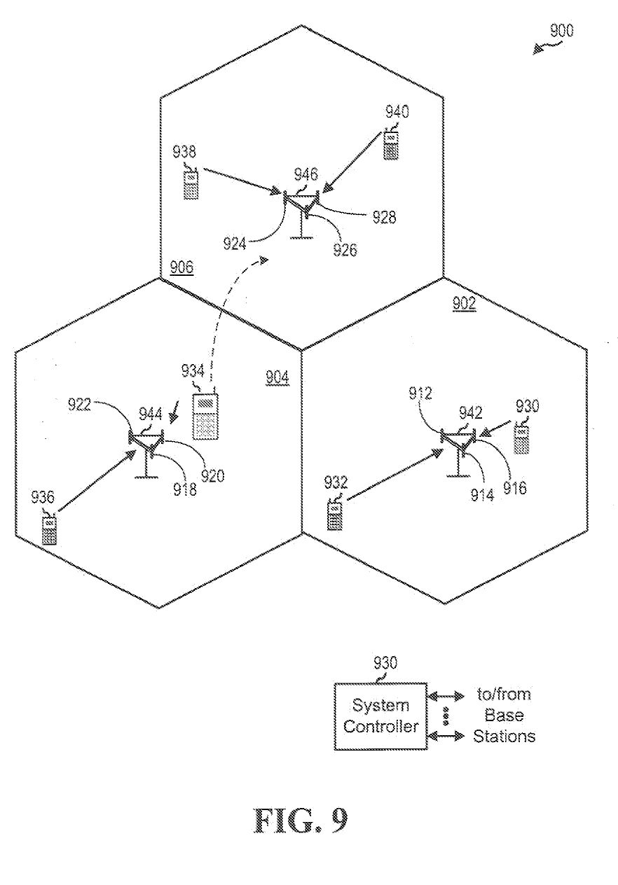

Referring to FIG. 9, a multiple access wireless communication system 900 is illustrated. The multiple access wireless communication system 900 includes multiple cells, including cells 902, 904, and 906. In the aspect the system 900, the cells 902, 904, and 906 may include a Node B that includes multiple sectors. The multiple sectors can be formed by groups of antennas with each antenna responsible for communication with UEs in a portion of the cell. For example, in cell 902, antenna groups 912, 914, and 916 may each correspond to a different sector. In cell 904, antenna groups 918, 920, and 922 each correspond to a different sector. In cell 906, antenna groups 924, 926, and 928 each correspond to a different sector. The cells 902, 904 and 906 can include several wireless communication devices, e.g., User Equipment or UEs, which can be in communication with one or more sectors of each cell 902, 904 or 906. For example, UEs 930 and 932 can be in communication with Node B 942, UEs 934 and 936 can be in communication with Node B 944, and UEs 938 and 940 can be in communication with Node B 946.

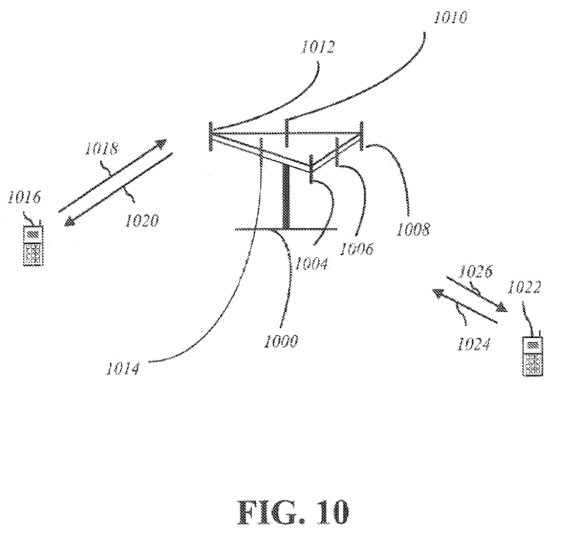

Referring now to FIG. 10, a multiple access wireless communication system according to one aspect is illustrated. An access point 1000 (AP) includes multiple antenna groups, one including 1004 and 1006, another including 1008 and 1010, and an additional including 1012 and 1014. In FIG. 10, only two antennas are shown for each antenna group, however, more or fewer antennas may be utilized for each antenna group. Access terminal 1016 (AT) is in communication with antennas 1012 and 1014, where antennas 1012 and 1014 transmit information to access terminal 1016 over forward link 1020 and receive information from access terminal 1016 over reverse link 1018. Access terminal 1022 is in communication with antennas 1006 and 1008, where antennas 1006 and 1008 transmit information to access terminal 1022 over forward link 1026 and receive information from access terminal 1022 over reverse link 1024. In a FDD system, communication links 1018, 1020, 1024 and 1026 may use different frequency for communication. For example, forward link 1020 may use a different frequency then that used by reverse link 1018.

Each group of antennas and/or the area in which they are designed to communicate is often referred to as a sector of the access point. Antenna groups each are designed to communicate to access terminals in a sector, of the areas covered by access point 1000. In communication over forward links 1020 and 1026, the transmitting antennas of access point 1000 utilize beam-forming in order to improve the signal-to-noise ratio of forward links for the different access terminals 1016 and 1024. Also, an access point using beam-forming to transmit to access terminals scattered randomly through its coverage causes less interference to access terminals in neighboring cells than an access point transmitting through a single antenna to all its access terminals. An access point may be a fixed station used for communicating with the terminals and may also be referred to as an access point, a Node B, or some other terminology. An access terminal may also be called an access terminal, user equipment (UE), a wireless communication device, terminal, access terminal or some other terminology.

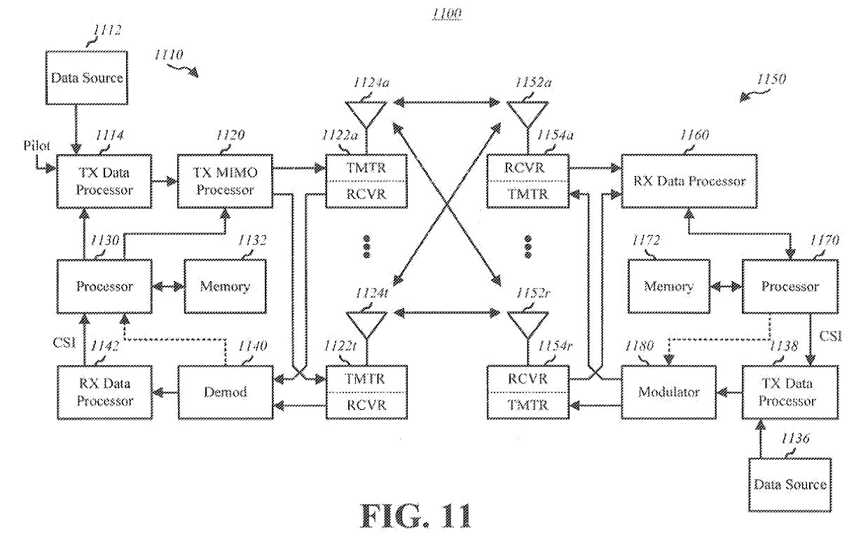

Referring to FIG. 11, a system 1100 illustrates a transmitter system 210 (also known as the access point) and a receiver system 1150 (also known as access terminal) in a MIMO system 1100. At the transmitter system 1110, traffic data for a number of data streams is provided from a data source 1112 to a transmit (TX) data processor 1114. Each data stream is transmitted over a respective transmit antenna. TX data processor 1114 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 1130.

The modulation symbols for all data streams are then provided to a TX MIMO processor 1120, which may further process the modulation symbols (e.g., for OFDM). TX MIMO processor 1120 then provides NT modulation symbol streams to NT transmitters (TMTR) 1122a through 1122t. In certain embodiments, TX MIMO processor 1120 applies beam-forming weights to the symbols of the data streams and to the antenna from which the symbol is being transmitted.

Each transmitter 1122 receives and processes a respective symbol stream to provide one or more analog signals, and further conditions (e.g., amplifies, filters, and up-converts) the analog signals to provide a modulated signal suitable for transmission over the MIMO channel. NT modulated signals from transmitters 1122a through 1122t are then transmitted from NT antennas 1124a through 1124t, respectively.

At receiver system 1150, the transmitted modulated signals are received by NR antennas 1152a through 1152r and the received signal from each antenna 1152 is provided to a respective receiver (RCVR) 1154a through 1154r. Each receiver 1154 conditions (e.g., filters, amplifies, and down-converts) a respective received signal, digitizes the conditioned signal to provide samples, and further processes the samples to provide a corresponding “received” symbol stream.

An RX data processor 1160 then receives and processes the NR received symbol streams from NR receivers 1154 based on a particular receiver processing technique to provide NT “detected” symbol streams. The RX data processor 1160 then demodulates, de-interleaves, and decodes each detected symbol stream to recover the traffic data for the data stream. The processing by RX data processor 1160 is complementary to that performed by TX MIMO processor 1120 and TX data processor 1114 at transmitter system 1110.

A processor 1170 periodically determines which pre-coding matrix to use (discussed below). Processor 1170 formulates a reverse link message comprising a matrix index portion and a rank value portion. The reverse link message may comprise various types of information regarding the communication link and/or the received data stream. The reverse link message is then processed by a TX data processor 1138, which also receives traffic data for a number of data streams from a data source 1136, modulated by a modulator 1180, conditioned by transmitters 1154a through 1154r, and transmitted back to transmitter system 1110.

At transmitter system 1110, the modulated signals from receiver system 1150 are received by antennas 1124, conditioned by receivers 1122, demodulated by a demodulator 1140, and processed by a RX data processor 1142 to extract the reserve link message transmitted by the receiver system 1150. Processor 1130 then determines which pre-coding matrix to use for determining the beam-forming weights then processes the extracted message.

In an aspect, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. Logical Traffic Channels comprise a Dedicated Traffic Channel (DTCH) which is Point-to-point bi-directional channel, dedicated to one UE, for the transfer of user information. Also, a Multicast Traffic Channel (MTCH) for Point-to-multipoint DL channel for transmitting traffic data.

Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels comprises:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

In an aspect, a channel structure is provided that preserves low PAR (at any given time, the channel is contiguous or uniformly spaced in frequency) properties of a single carrier waveform.

It is noted that various aspects are described herein in connection with a terminal. A terminal can also be referred to as a system, a user device, a subscriber unit, subscriber station, mobile station, mobile device, remote station, remote terminal, access terminal, user terminal, user agent, or user equipment. A user device can be a cellular telephone, a cordless telephone, a Session Initiation Protocol (SIP) phone, a wireless local loop (WLL) station, a PDA, a handheld device having wireless connection capability, a module within a terminal, a card that can be attached to or integrated within a host device (e.g., a PCMCIA card) or other processing device connected to a wireless modem.

Moreover, aspects of the claimed subject matter may be implemented as a method, apparatus, or article of manufacture using standard programming and/or engineering techniques to produce software, firmware, hardware, or any combination thereof to control a computer or computing components to implement various aspects of the claimed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving voice mail or in accessing a network such as a cellular network. Of course, those skilled in the art will recognize many modifications may be made to this configuration without departing from the scope or spirit of what is described herein.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for reserving bandwidth in a wireless system, comprising:
reserving one or more communications slots between two or more wireless devices communicating in a wireless network;
providing preferential access to at least one wireless device across the wireless network according to a first subset of the communications slots; and
providing preferential access to at least one other wireless device across the wireless network during a second subset of the communications slots.

2. The method of claim 1, where preferential access allows access to the wireless network without contending for access with at least one other device.

3. The method of claim 1, further comprising dividing a first αN (where 0<α<1) medium access slots (MAS) slots between A and B in a ratio of their respective traffic proportions, where out of αN slots, A has preferential access in
$$α N \frac{d}{d + u}$$
slots while B has preferential access in
$$α N \frac{u}{d + u}$$
slots, where A is a first wireless device, B is a second wireless device, N is a number of slots.

4. The method of claim 3, further comprising adjusting a prioritized contention access (PCA) parameter, an arbitrary interframe spacing (AIFS) parameter, and a contention window maximum (CWmax) parameter to ensure fairness over a distributed reservation protocol (DRP) period.

5. The method of claim 4, utilizing the equation
$$\frac{{S}_{A} + {S}_{A}^{′}}{{S}_{B} + {S}_{B}^{′}} = \frac{d}{u}$$
to facilitate fairness, where S_{A} and S_{B} are the number of MAS slots in which A and B had transmitted data during the first αN MAS slots, S_{A}′ and S_{B}′ are the number of MAS slots during the PCA period over which A and B are assigned access to a medium, and
$$\frac{d}{u}$$
is a ratio of (download/upload).

6. The method of claim 5, further comprising adjusting AIFS or CWₘₐₓ as a function of an inverse ratio S_{A}′ and S_{B}′.

7. The method of claim 5, further comprising setting the ratio of
$$\frac{d}{u}$$
to an initial value of 1:1, observing a traffic pattern, and adjusting the ratio overtime according to the pattern.

8. The method of claim 7, further comprising winning contention for a medium and continuing to transmit data until a buffer is empty or a transmit opportunity (TXOP) expires.

9. The method of claim 4, further comprising transmitting on a medium when it is sensed that the medium is idle.

10. The method of claim 4, further comprising adjusting the CWmax parameter for each device for the next MAS slot depending on the number of MAS slots won by each device during a PCA period.

11. The method of claim 4, further comprising increasing the value of a to 1 and eliminating a PCA period.

12. The method of claim 11, further comprising providing at least one other contention free access period in lieu of the PCA period.

13. The method of claim 4, further comprising applying the following constraint to facilitate bandwidth fairness: CW_{max,N}>max(CW_{max,A},CW_{max,B}) where N ∈ {A,B}.

14. A communications apparatus, comprising:
a memory that retains instructions for reserving two or more communications slots between two or more wireless devices while enabling preferential access to at least one wireless device according to a subset of the communications slots; and
a processor that executes the instructions.

15. The apparatus of claim 14, further comprising instructions for dividing a first αN (where 0<α<1) medium access slots (MAS) slots between A and B in a ratio of their respective traffic proportions, where out of αN slots, A has preferential access in
$$α N \frac{d}{d + u}$$
slots while B has preferential access in
$$α N \frac{u}{d + u}$$
slots, where A is a first wireless device, B is a second wireless device, N, is a number of slots.

16. The apparatus of claim 15, further comprising instructions for adjusting a prioritized contention access (PCA) parameter, an arbitrary interframe spacing (AIFS) parameter, and a contention window maximum (CWmax) parameter to ensure fairness over a distributed reservation protocol (DRP) period.

17. The apparatus of claim 16, further comprising utilizing instruction
$$\frac{{S}_{A} + {S}_{A}^{′}}{{S}_{B} + {S}_{B}^{′}} = \frac{d}{u}$$
to facilitate fairness, where S_{A} and S_{B} are the number of MAS slots in which A and B had transmitted data during the first αN MAS slots, S_{A}′ and S_{B}′ are the number of MAS slots during the PCA period over which A and B are assigned access to a medium, and
$$\frac{d}{u}$$
is a ratio of (download/upload).

18. The apparatus of claim 17, further comprising adjusting AIFS or CWmax as a function of an inverse ratio S_{A}′ and S_{B}′.

19. A communications apparatus, comprising:
means for assigning one or more communications slots between at least two wireless devices communicating in a wireless network; and
means for granting preferential access to one wireless device across the wireless network according to a subset of the communications slots.

20. The apparatus of claim 19, further comprising means for granting preferential access to at least one other wireless device across the wireless network during at least one other subset of the communications slots.

21. A computer-readable medium, comprising:
reserving two or more subsets of prioritized contention access (PCA) slots between two or more wireless devices communicating in a wireless network;
providing preferential access to at least one wireless device across the wireless network according to at least one subset of the PCA slots; and
providing preferential access to at least one other wireless device across the wireless network during at least one other subset of the PCA slots.

22. A processor that executes the following instructions:
allocating two or more subsets of prioritized contention access (PCA) slots between two or more wireless devices communicating in a wireless network;
granting transmission access to at least one wireless device across the wireless network according to at least one subset of the PCA slots; and
granting transmission access to at least one other wireless device across the wireless network during at least one other subset of the PCA slots.

23. A communications apparatus, comprising:
means for assigning one or more communications slots between at least two wireless devices communicating in a wireless network;
means for granting preferential access to one wireless device across the wireless network according to a subset of the communications slots; and
means for adjusting at least one of a prioritized contention access (PCA) parameter, an arbitrary interframe spacing (AIFS) parameter, and a contention window maximum (CWmax) parameter to ensure fairness over a distributed reservation protocol (DRP) period set for the wireless network.
